(19) United States
(12) Patent Application Publication
(10) Pub. No.: US 2011/0239937 A1
(43) Pub. Date: Oct. 6, 2011

(54) APPARATUS AND METHOD FOR TREATING SUBSTRATE

(75) Inventors: Yohan Ahn, Yongin-si (KR); Jinho Kim, Hwaseong-si (KR); Bum-Soo Kim, Seoul (KR)

(73) Assignee: SAMSUNG ELECTRONICS CO., LTD., Gyeonggi-do (KR)

(21) Appl. No.: 13/053,870

(22) Filed: Mar. 22, 2011

(30) Foreign Application Priority Data
Apr. 6, 2010 (KR) 10-2010-0031477

(51) Int. Cl. B05C 9/08; B05C 9/14; B05C 11/00; B05C 13/00; F28F 7/00

(52) U.S. Cl. 118/696; 118/69; 165/185

(57) ABSTRACT

A substrate treating apparatus and method include a load lock chamber providing a space where a process is performed. While a boat supporting the substrate is positioned in the load lock chamber, a cooling member cools an inside of the load lock chamber at different temperatures according to area or region in a vertical direction of the load lock chamber.

### CROSS-REFERENCE TO RELATED APPLICATIONS

This U.S. non-provisional patent application claims priority under 35 U.S.C. §119 of Korean Patent Application No. 10-2010-0031477, filed on Apr. 6, 2010, the entire contents of which are hereby incorporated by reference.

### BACKGROUND

The present inventive concept herein relates to an apparatus and method for treating a substrate, and more particularly, to an apparatus and method for forming a thin layer on a substrate.

A low pressure chemical vapor deposition (LPCVD) process used in semiconductor manufacturing is used to deposit a thin layer on a surface of a substrate at a low pressure. LPCVD has been widely used in recent years because the uniformity of the deposited layer is good, the process may be performed at the same time for a plurality of wafers, and gas consumption may bereduced to reduce production cost.

A vertical diffusion furnace is generally used as an apparatus for performing the LPCVD process. In the vertical diffusion furnace, a process tube and a load lock chamber are disposed in an up-and-down or vertical direction.

### SUMMARY

The present inventive concept provides an apparatus and method for treating a substrate that can cool an inner space of a load lock chamber.

The present inventive concept also provides an apparatus and method for treating a substrate that can prevent the substrate from being contaminated due to fine particles.

The present inventive concept also provides an apparatus and method for treating a substrate that can shorten the process time.

According to one aspect, the inventive concept is directed to an apparatus for treating a substrate. The apparatus includes: a processing chamber providing a space where a process is performed; a heating member heating the processing chamber; a load lock chamber coupled to the processing chamber; a boat supporting the substrate; a boat driving member transferring the boat between the processing chamber and the load lock chamber; and a cooling member cooling an inside of the load lock chamber. The cooling member is provided such that the inside of the load lock chamber is cooled at different temperatures according to region in the load lock chamber.

In one embodiment, the cooling member comprises a circulation duct having a plurality of passages for circulating a gas in the load lock chamber; each of the plurality of passages has an inlet through which the gas is introduced from the inside of the load lock chamber, and an outlet through which the gas is exhausted to the load lock chamber; and the outlets of the plurality of passages are positioned at different heights.

In one embodiment, the plurality of passages comprise a first passage having a first outlet and a second passage having a second outlet disposed at a lower level than the first outlet. The cooling member further comprises a first cooler positioned in the first passage to cool the gas. In one embodiment, the cooling member further comprises a second cooler positioned in the second passage to cool the gas. In one embodiment, the cooling member further comprises a temperature controller independently controlling the first cooler and the second cooler.

In one embodiment, the first passage has a first inlet, the second passage has a second inlet, and the first inlet is positioned below the second inlet.

In one embodiment, the cooling member is provided along a passage of the circulation duct and further comprises a wall partitioning the first passage and the second passage from each other.

In one embodiment, the second passage is positioned at an area between the load lock chamber and the first passage.

In one embodiment, the boat is provided such that the plurality of substrates are stacked spaced apart from each other in the vertical direction. In one embodiment, the inside of the load lock chamber is partitioned into an upper region to which the gas is supplied from the first and second outlets and a lower region positioned below the upper region, from which the gas is supplied to the first and second inlets. The upper region comprises a first supply region to which the gas is supplied from the first outlet and a second supply region disposed below the first supply region, to which the gas is supplied from the second outlet. The lower region comprises a first introduction region to which the gas is introduced through the first inlet and a second introduction region disposed above the first introduction region, to which the gas is introduced through the second inlet.

In one embodiment, the load lock chamber is disposed below the processing chamber.

In one embodiment, the inside of the load lock chamber is cooled at different temperatures according to region of the load lick camber in a vertical direction.

According to another aspect, the inventive concept is directed to an apparatus for treating a substrate. The apparatus comprises: a chamber having a space formed therein; a circulation duct providing a plurality of passages through which a gas in the chamber is circulated; and a cooling member installed in the circulation duct to cool the gas in the plurality of passages, independently.

In one embodiment, the plurality of passages have inlets through which the gas is introduced from the chamber and outlets through which the gas is exhausted to the chamber. The outlets are positioned at different heights.

In one embodiment, the circulation duct comprises a first passage having a first outlet and a second passage disposed at a lower position than the first outlet, and having a second outlet. The cooling member comprises a first cooler disposed on the first passage and a second cooler disposed on the second passage.

In one embodiment, the cooling member further comprises a temperature controller controlling the first cooler and the second cooler independently.

In one embodiment, the cooling member further comprises a wall provided along a passage of the circulation duct the wall partitioning the first passage and the second passage from each other.

According to another aspect, the inventive concept is directed to a method for treating a substrate. The method includes: performing a process treatment with respect to the substrate supported in a boat while an inside of a processing chamber is heated at a process temperature; transferring the boat to a load lock chamber positioned below the processing chamber; and cooling an inside of the load lock chamber at different temperatures according to region of the load lock chamber.

In one embodiment, the cooling of the inside of the load lock chamber is different in a vertical direction of the inside of the load lock chamber. In one embodiment, the cooling of the inside of the load lock chamber is performed by circulating a gas in the load lock chamber through a circulation duct having a plurality of passages formed therein, and independently cooling the gas circulating through the plurality of passages and supplying the independently cooled gas to the load lock chamber. Regions of the inside of the load lock chamber to which the gas is supplied through the plurality of passages are different.

In one embodiment, the passages include a first passage having a first inlet and a first outlet and a second passage having a second inlet and a second outlet. The inside of the load lock chamber is partitioned into an upper region to which the gas is supplied from the first and second outlets and a lower region positioned below the upper region, from which the gas is supplied to the first and second inlets. The upper region comprises a first supply region to which the gas is supplied from the first outlet and a second supply region disposed below the first supply region, to which the gas is supplied from the second outlet. The temperature of the gas supplied to the first supply region is lower than that of the gas supplied to the second supply region. In one embodiment, the first supply region is a region adjacent to the processing chamber.

According to another aspect, the inventive concept is directed to a method of treating a substrate. The method includes: providing a chamber having a space formed therein; circulating a gas in the chamber through a circulation duct having a plurality of passages; and using a cooling member installed in the circulation duct, cooling a plurality of portions of the gas circulating respectively in the plurality of passages, the cooling of the portions of the gas being performed independently, such that temperature of regions of the space associated respectively with the passages varies depending upon the associated passages.

In one embodiment, the plurality of passages have inlets through which the gas is introduced from the space, and outlets through which the gas is exhausted to the chamber, and the outlets are positioned at different heights.

In one embodiment, the circulation duct comprises a first passage having a first outlet and a second passage disposed at a lower position than the first outlet, and having a second outlet. The cooling member comprises a first cooler disposed on the first passage and a second cooler disposed on the second passage.

In one embodiment, the cooling member further comprises a temperature controller controlling the first cooler and the second cooler independently.

In one embodiment, the cooling member further comprises a wall provided along a passage of the circulation duct, the wall partitioning the first passage and the second passage from each other.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to describe principles of the inventive concept.

FIG. 1 is a schematic sectional view of an apparatus for treating a substrate according to an embodiment of the inventive concept.

FIG. 2 is a schematic cross-sectional view taken along line a-a′ of FIG. 1.

FIGS. 3 to 7 are schematic sectional views illustrating substrate treating apparatuses according to other embodiments of the inventive concept.

FIG. 8 is a flowchart showing a substrate treating process according to an embodiment of the inventive concept.

FIG. 9 is a schematic diagram showing the process treating step illustrated in FIG. 8.

FIG. 10 is a schematic diagram showing the cooling step illustrated in FIG. 8.

FIG. 11A is a graph showing an inner temperature of the load lock chamber before the cooling member according to the inventive concept is driven.

FIG. 11B is a graph showing the inner temperature of the load lock chamber while the cooling member according to the inventive concept is driven.

### DETAILED DESCRIPTION OF THE EMBODIMENTS

Exemplary embodiments of the inventive concept will be described below in more detail with reference to the accompanying drawings. The inventive concept may, however, be embodied in many different forms and should not be construed as being limited to the embodiments set forth herein; rather, these embodiments are provided so that this description will be thorough and complete, and will fully convey the inventive concept to those skilled in the art. In the drawings, the thicknesses of layers and regions may be exaggerated for clarity.

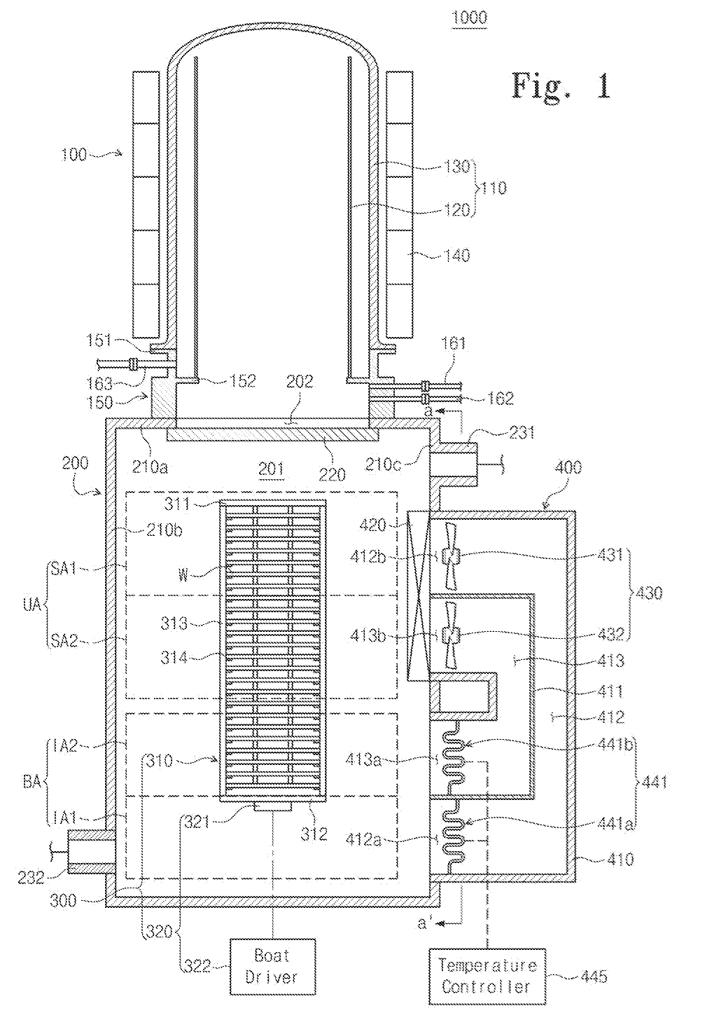

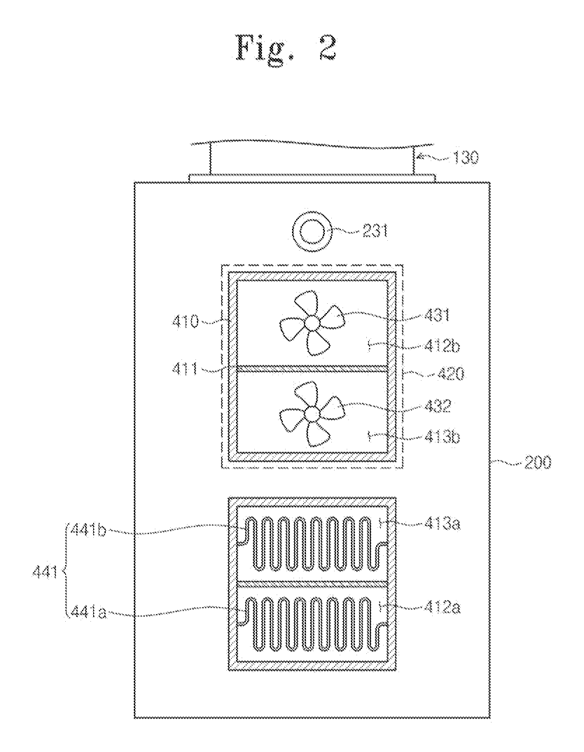

FIGS. 1 and 2 are schematic views illustrating an apparatus for treating a substrate according to an embodiment of the inventive concept. Specifically, FIG. 1 is a schematic sectional view of an apparatus for treating a substrate, and FIG. 2 is a schematic cross-sectional view taken along line a-a′ of FIG. 1.

Referring to FIGS. 1 and 2, a substrate treating apparatus 1000 includes a processing chamber 100, a load lock chamber 200, a substrate supporting member 300, and a cooling member 400. The processing chamber 100 provides a space where a process such as a diffusion process or deposition process is performed, and the load lock chamber 200 provides a space for loading/unloading a substrate W to/from a boat 310. The substrate supporting member 300 supports the substrate W while a process is performed, and transfers the substrate W between the processing chamber 100 and the load lock chamber 200. The cooling member 400 cools an inside of the load lock chamber 200 at temperatures which can be different in different areas or regions in the load lack chamber.

A process tube 110 providing a space where a process for forming a thin layer with respect to the substrate W is performed is disposed in the processing chamber 100. The process tube 110 has an inner tube 120 made of quartz and an outer tube 130 made of quartz. The inner tube 120 has a cylindrical shape of which upper and lower ends are opened. The outer tube 130 has a body portion having a cylindrical shape of which a lower end is opened, and an upper portion having a dome shape. The outer tube 130 is installed to enclose the inner tube 120 and to be spaced apart from the inner tube 120.

A heating member 140 is disposed on an outer wall of the outer tube 130 so as to enclose the body portion of the outer tube 130. The heating member 140 maintains the interior of the outer tube 130 and the inner tube 120 at a process temperature while a process is performed. According to an embodiment, the process temperature Tp is in a range of approximately 600° C. to approximately 900° C. After the process is completed, the heating member 140 maintains the temperature of the process tube 110 at a preliminary temperature Ts. The preliminary temperature Ts is lower than the process temperature Tp. According to an embodiment, the preliminary temperature Ts is in a range of approximately 400° C. to approximately 600° C.

The inner tube 120 and the outer tube 130 are supported by a flange 150 disposed under the inner tube 120 and the outer tube 130. The flange 150 has a passage hole formed at a center thereof, and the process tube 110 communicates with the load lock chamber 200 disposed under the process tube 110 through the passage hole. The flange 150 has a cylindrical shape of which upper and lower ends are opened, and has a diameter similar to that of the outer tube 130.

The flange 150 is provided with an outer pedestal 151 supporting the outer tube 130, and an inner pedestal 152 supporting the inner tube 120. The outer pedestal 151 is formed in a ring shape and extends outwardly from an upper end of the flange 150. The inner pedestal 152 is formed in a ring shape and extends inwardly from an inner wall of the flange 150.

A process gas supply nozzle 161 supplying process gas into the process tube 110 and a purge gas supply nozzle 162 supplying purge gas into the process tube 110 are provided at one side surface of the flange 150. A gas exhaust pipe 163 exhausting gas in the process tube 110 to the outside is connected to the other side surface of the flange 150. While a process is performed, the inside of the process tube 110 is maintained at a low pressure and reaction products generated in the process tube 110 are forcibly exhausted to the outside via the gas exhaust pipe 163.

The process gas supply nozzle 161 and the purge gas supply nozzle 162 are vertically positioned lower than the inner pedestal 152, and the gas exhaust pipe 163 is vertically positioned between the inner pedestal 152 and the outer pedestal 151. By the foregoing structure, process gas is introduced into the inner tube 120 and is deposited on the substrates W loaded on the boat 310 while flowing in an upward direction. After the process is completed, residual gases flow from the upper side to the lower side along the space between the outer tube 130 and the inner tube 120 and are exhausted to the outside through the gas exhaust pipe 163.

The load lock chamber 200 is positioned under the flange 150. The load lock chamber 200 has a space 201 where the substrate W is loaded/unloaded to/from the boat 310. An opening 202 is formed in an upper wall 210a of the load lock chamber 300. The opening 202 is provided as a passage through which the boat 310 moves. The opening 202 is formed with a diameter corresponding to the passage hole formed in the center of the flange 150.

A sealing member (not shown) for preventing process gas provided to the process tube 110 from being leaked to the outside may be provided between the upper wall 210a of the load lock chamber 200 and the flange 150.

A shutter 220 is provided in the load lock chamber 200. The shutter 220 is installed adjacent to the upper wall 210a of the load lock chamber 200 to open and close the opening 202. The shutter 220 closes the opening 202 while the boat 310 is positioned in the processing chamber 100 for a process or the boat 310 is positioned in the load lock chamber 200 to perform loading and unloading of the substrate W. The shutter 220 opens the opening 202 while the boat 310 moves between the processing chamber 100 and the load lock chamber 200.

A gas supply pipe 231 and a gas exhaust pipe 232 are provided to a sidewall 210b of the load lock chamber 200. The gas supply pipe 231 supplies gas into the load lock chamber 200. The gas supplied into the load lock chamber 200 may be an inert gas such as air or nitrogen gas. The gas exhaust pipe 232 exhausts some of the gas in the load lock chamber 200 to the outside of the load lock chamber 200. The gas supply pipe 231 and the gas exhaust pipe 232 are provided in both sidewalls 210b and 210c of the load lock chamber 200 facing each other. The gas supply pipe 231 is provided in an upper area of one sidewall 210c and the gas exhaust pipe 232 is provided in a lower area of the other sidewall 210b. Alternatively, the gas supply pipe 231 and the gas exhaust pipe 232 may be provided at the same height level. A gas introduced into the load lock chamber 200 through the gas supply pipe 231 is supplied to the substrates W and is then exhausted to the outside of the load lock chamber 200 through the gas exhaust pipe 232.

The substrate supporting member 300 includes a boat 310 supporting the substrates W, and a boat driving unit 320 transferring the boat 310 between the processing chamber 100 and the load lock chamber 200.

The boat 310 includes an upper plate 311, a lower plate 312, and vertical supporting bars 313. The upper plate 311 and the lower plate 312 are provided in a circular plate shape and are disposed facing each other in an up and down direction. The plurality of vertical supporting bars 313 are coupled between the upper plate 311 and the lower plate 312. The vertical supporting bars 313 may be three to four in number, and each of the vertical supporting bars 313 is provided in a vertically elongated rod shape. Each of the vertical supporting bars 313 has a plurality of pedestals 314 spaced apart by a predetermined distance from one another along the length direction thereof. A portion of an edge region of each substrate W is placed on the pedestals 314. Each of the substrates W is supported by three to four pedestals 314 disposed on the same plane. According to an embodiment, the pedestals 314 are configured to support 50 to 100 substrates W at the same time.

The boat driving unit 320 includes a drive shaft 321 and a boat driver 322. The drive shaft 321 is positioned under the boat 310 to support the boat 310. The boat driver 322 is connected to the drive shaft 321 to move the drive shaft 321 up and down. The boat driver 322 allows the boat 310 to be positioned in the processing chamber 100 while a process for the substrate W is performed, and allows the boat 310 to be positioned in the load lock chamber 200 while the substrate W is loaded/unloaded.

The cooling member 400 cools the inside of the load lock chamber 200. The cooling member 400 cools the inside of the load lock chamber 200 at different temperatures according to different areas or regions in the vertical direction. The load lock chamber 200 has a circulation duct 410 configured to circulate a gas within the load lock chamber 200. The circulation duct 410 is positioned outside the load lock chamber 200. The circulation duct 410 is provided with a plurality of passages 412, 413 through which gas circulates. The plurality of passages 412, 413 are partitioned by a wall 411 provided in and along the circulation duct 410. Each of the plurality of passages 412, 413 has inlets 412a, 413a through which gas is introduced from the load lock chamber 200, and outlets 412b, 413b through which gas is exhausted to the load lock chamber 200. The outlets 412b, 413b are positioned at different heights and connected to the inside of the load lock chamber 200.

According to an embodiment, the circulation duct 410 is also provided with two passages 412, 413, for example, first passage 412 and second passage 413. The first and second passages 412 and 413 are provided in the circulation duct 410 along the length direction of the circulation duct 410. The second passage 413 is positioned at an area between the first passage 412 and the load lock chamber 200. The first passage 412 and the second passage 413 are partitioned by the wall 411 provided in and along the circulation duct 410. The first passage 412 has the first inlet 412a and the first outlet 412b, and the second passage 413 has the second inlet 413a and the second outlet 413b. The first and second outlets 412b and 413b are vertically positioned at higher levels than the first and second inlets 412a and 413a and are connected to the inside of the load lock chamber 200. Also, the first outlet 412b is vertically positioned at a higher level than the second outlet 413b and is connected to the inside of the load lock chamber 200, and the second inlet 413a is vertically positioned at a higher level than the first inlet 412a and is connected to the inside of the load lock chamber 200. The first and second outlets 412b and 413b and the first and second inlets 412a and 413a may be disposed on a vertical straight line. By the foregoing structure, the inside of the load lock chamber 200 is partitioned into an upper area or region UA where gas is supplied from the first and second outlets 412b and 413b, and a lower area or region BA where gas is supplied through the first and second inlets 412a and 413a. The lower area or region BA is vertically positioned under the upper area or region UA. The upper area or region UA is divided into a first supply area or region SA1 where gas is supplied from the first outlet 412b, and a second supply area or region SA2 where gas is supplied from the second outlet 413b. The first supply area or region SA1 is an area or region which is vertically positioned above the second supply area or region SA2 and is adjacent to the processing chamber 100. The lower area or region BA is divided into a first introduction area or region IA1 where gas is introduced through the first inlet 412a, and a second introduction area or region IA2 where gas is introduced through the second inlet 413a. The second introduction area or region IA2 is vertically positioned above the first introduction area or region IA1. The first supply area or region SA1, the second supply area or region SA2, the second introduction area or region IA2, and the first introduction area or region IA1 are disposed in the load lock chamber 200 in order from top to bottom.

A filter 420 is disposed in the load lock chamber 200. The filter 420 is disposed adjacent to the outlets 412b and 413b. The filter 420 filters gas exhausted from the outlets 412b and 413b. The filter 420 has a sufficient area such that gas exhausted from the outlets 412b and 413b may pass through the filter 420 and may be supplied into the load lock chamber 200.

Blowers 430 are respectively installed on the passages 412 and 413 of the circulation duct 410. The blowers 430 inhale gas from the passages 412, 413 and exhaust the inhaled gas from the passages 412, 413. According to an embodiment, the first blower 431 is installed adjacent to the first outlet 412b on the first passage 412, and the second blower 432 is installed adjacent to the second outlet 413b on the second passage 413.

A cooler 441 is provided to one or more of the passages 412, 413 of the circulation duct 410. The cooler 441 cools gas circulating through the passages 412, 413. According to an embodiment, a first cooler 441a is provided to the first passage 412, and a second cooler 441b is provided to the second passage 413. The first cooler 441a is provided adjacent to the first inlet 412a, and the second cooler 441b is provided adjacent to the second inlet 413a.

The first cooler 441a and the second cooler 441b are controlled by a temperature controller 442. The temperature controller 442 controls the first cooler 441a and the second cooler 441b independently such that temperature of gas circulating through the first passage 412 can be different from temperature of gas circulating through the second passage 413. According to one embodiment, the temperature controller 442 controls the first cooler 441a and the second cooler 441b such that temperature of gas circulating through the first passage 412 is lower than temperature of gas circulating through the second passage 413.

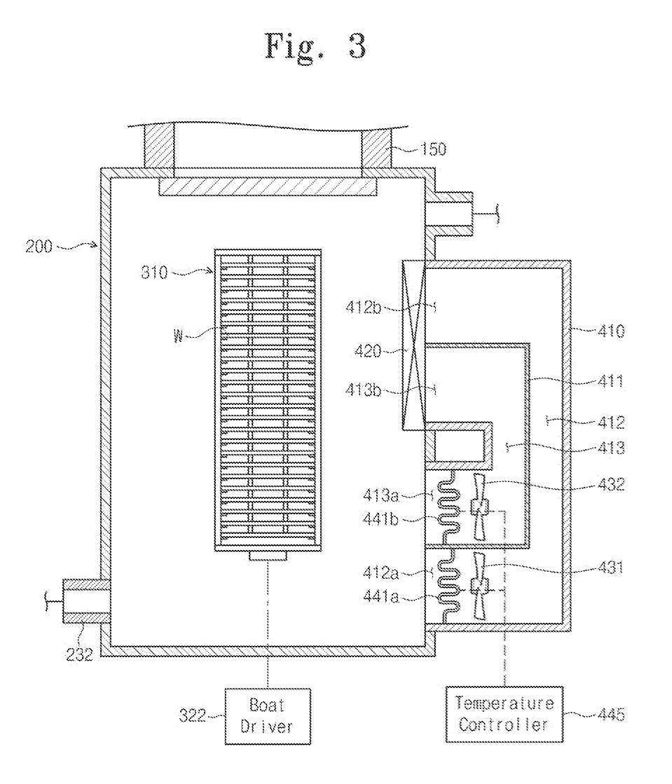

FIGS. 3 to 7 are schematic sectional views illustrating substrate treating apparatuses according to other embodiments of the inventive concept. Since a processing chamber in each of the substrate treating apparatuses of FIGS. 3 to 7 has the same construction as that of FIG. 1, the processing chamber is not shown, and description of the processing chamber is not repeated. Also, in FIGS. 3-7, detailed description of like elements to the elements of FIGS. 1 and 2 is not repeated.

Referring to FIG. 3, a first cooler 441a is positioned adjacent to a first inlet 412a on a first passage 412, and a second cooler 441b is positioned adjacent to a second inlet 413a on a second passage 413. Also, a first blower 431 is positioned adjacent to the first cooler 441a on the first passage 412, and a second blower 432 is positioned adjacent to the second cooler 441b on the second passage 413.

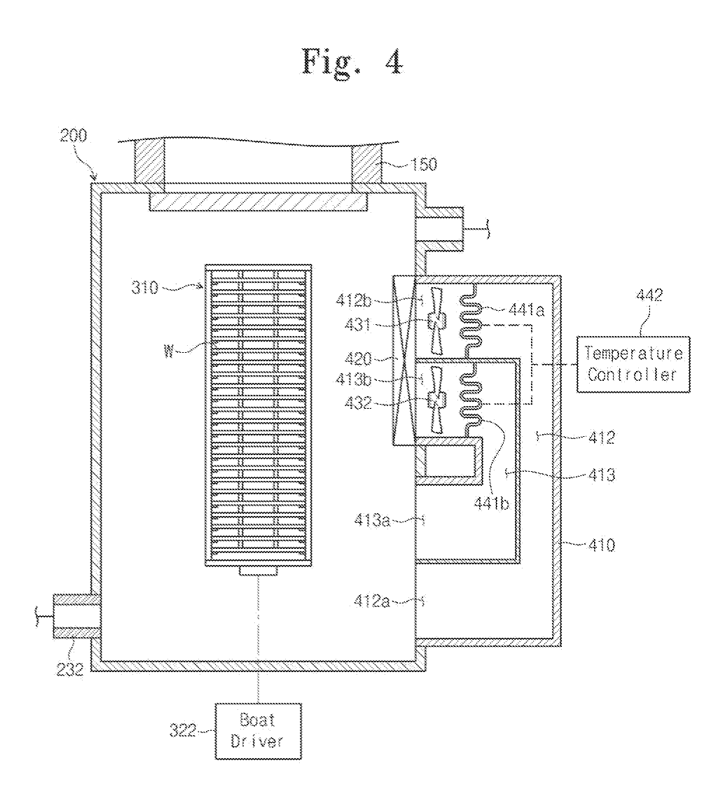

Referring to FIG. 4, a first blower 431 is positioned adjacent to a first outlet 412b on a first passage 412, and a second blower 432 is positioned adjacent to the second outlet 413b on a second passage 413. A first cooler 441a is positioned adjacent to the first blower 431 on the first passage 412, and a second cooler 441b is positioned adjacent to the second blower 432 on the second passage 413.

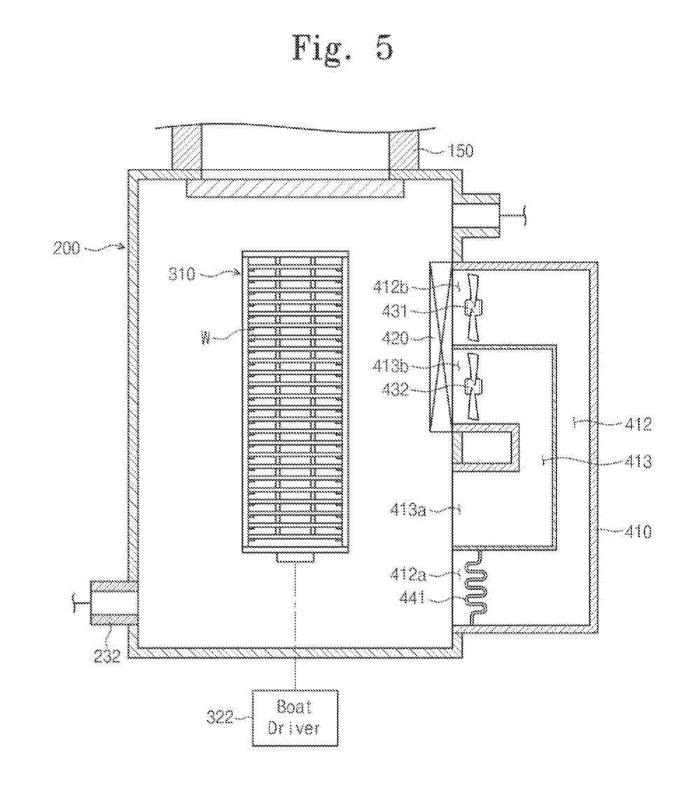

Referring to FIG. 5, a first blower 431 is positioned adjacent to a first outlet 412b on a first passage 412, and a second blower 432 is positioned adjacent to a second outlet 413b on a second passage 413. A cooler 441 is provided adjacent to a first inlet 412a only on the first passage 412. Gas circulating through the first passage 412 is forcibly cooled by the cooler 441, and gas circulating through the second passage 413 is naturally cooled by surrounding air of the circulation duct 410. Therefore, the gas circulating through the first passage 412 may be cooled to a lower temperature than the gas circulating through the second passage 413.

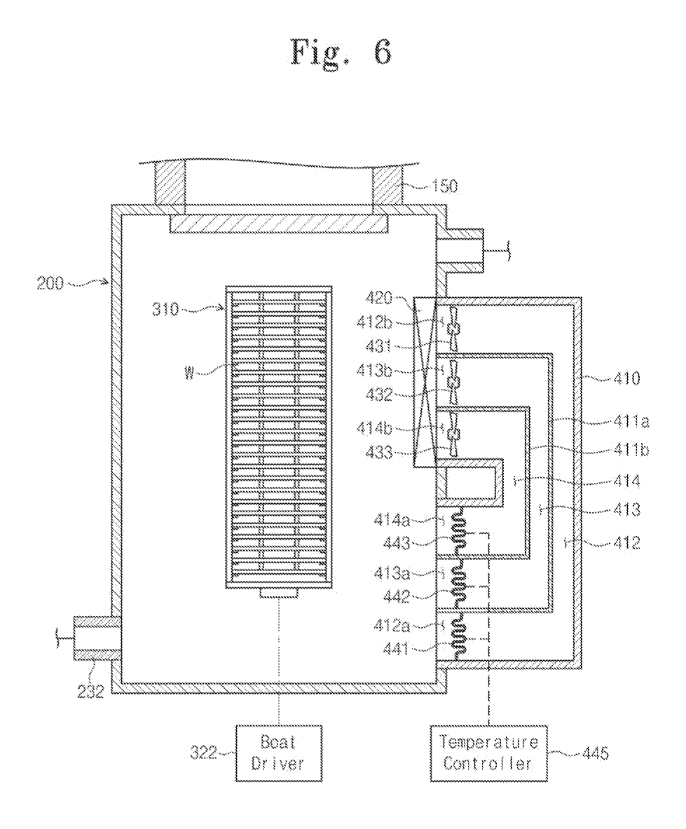

Referring to FIG. 6, three (first, second and third) passages 412, 413, 414 are provided in the circulation duct 410. The first passage 412 is positioned at an outer area in the circulation duct 410, and the third passage 414 is positioned at an inner area in the circulation duct 410. The second passage 413 is provided between the first passage 412 and the third passage 414. The first passage 412 and the second passage 413 are partitioned by a first wall 411a, and the second passage 413 and the third passage 414 are partitioned by a second wall 411b. A first outlet 412b, a second outlet 413b, and a third outlet 414b are sequentially connected to an upper area or region of a load lock chamber 200 from top to bottom. A third inlet 414a, a second inlet 413a, and a first inlet 412a are connected to a lower area or region of the load lock chamber 200 sequentially from top to bottom. Blowers 431, 432, 433 are provided adjacent to the outlets 412b, 413b, 414b on the respective passages 412, 413, 414. The coolers 441, 442, 443 are provided adjacent to the inlets 412a, 413a, 414a on the respective passages 412, 413, 414. A temperature controller 445 controls coolers 441, 442, 443 independently, such that temperatures of gases circulating through the respective passages 412, 413, and 414 can be different from each other. According to an embodiment, the temperature controller 445 controls the coolers 441, 442, 443 such that the gas circulating through the first passage 412 has a lower temperature than the gases circulating through the second and third passages 413 and 414. Also, the temperature controller 445 performs a temperature control such that the gas circulating through the second passage 413 has a lower temperature than the gas circulating through the third passage 414.

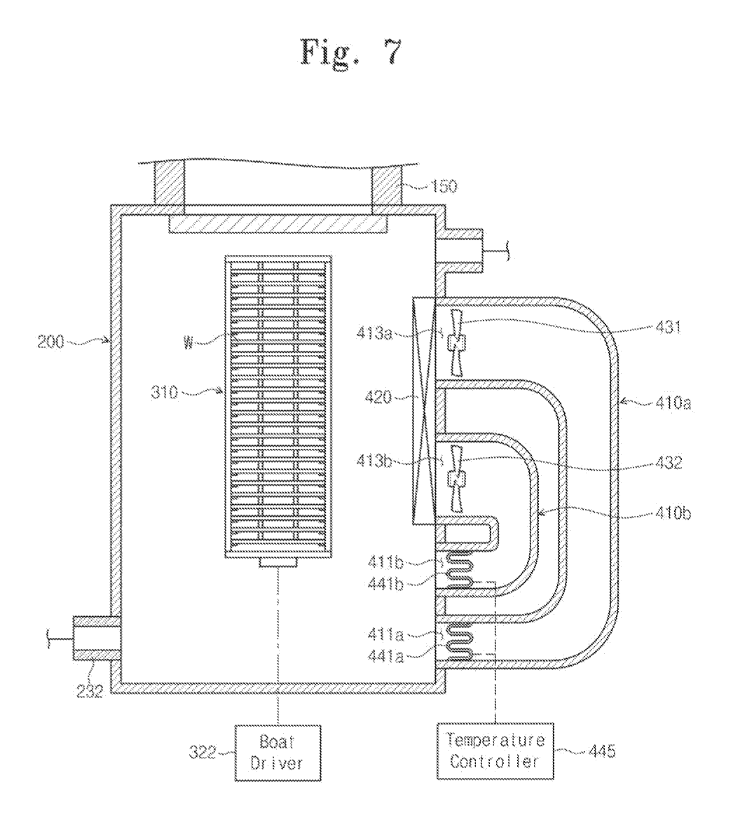

Referring to FIG. 7, gas in a load lock chamber 200 circulates through a plurality of circulation ducts 410a, 410b. One passage is formed in each of the plurality of circulation ducts 410a, 410b. Outlets 413a, 413b of the circulation ducts 410a, 410b are connected to an inside of the load lock chamber 200 at higher positions than inlets 411a, 411b. The outlet 413a of the first circulation duct 410a is vertically positioned at a higher level than the outlet 413b of the second circulation duct 410b. The inlet 411b of the second circulation duct 410b is vertically positioned at a higher level than the inlet 411a of the first circulation duct 410a. Blowers 431, 432 are provided adjacent to the outlets 413a, 413b in the respective circulation ducts 410a and 410b. Coolers 441a, 441b are provided adjacent to the inlets 411a, 411b in the respective circulation ducts 410a and 410b. A temperature controller 442 controls the first cooler 441a and a second cooler 441b independently, such that temperature of gas circulating through the first circulation duct 410a can be lower than that of gas circulating through the second circulation duct 410b.

As described above, in the embodiments of FIGS. 3-7, as in the embodiment of FIGS. 1 and 2, temperature of gas circulating through multiple circulation ducts is controlled independently, such that the temperature of gas flowing though different circulation ducts can be different. As a result, in the embodiments of FIGS. 3-7, as in the embodiment of FIGS. 1 and 2, the inside of the load lock chamber can attain different temperatures according to different areas or regions in the vertical direction.

A method of treating a substrate using, for example, the substrate treating apparatus having the foregoing construction according to embodiments of the inventive concept will be described below.

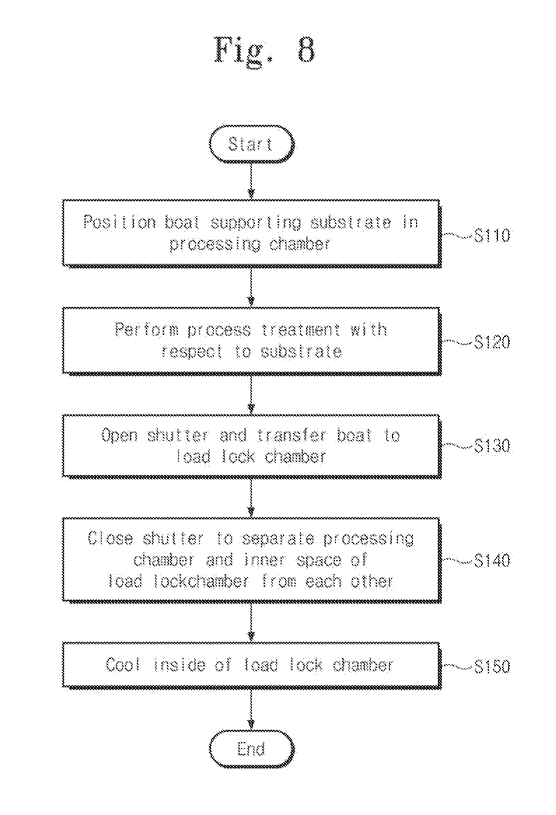

FIG. 8 is a flowchart showing a substrate treating process according to an embodiment of the inventive concept.

Referring to FIG. 8, a method of treating a substrate includes a preparing step (S110) which includes positioning a boat in which a substrate is supported in a processing chamber. In a process treating step (S120), a process treatment is performed with respect to the substrate. In a transfer step (S130), a shutter is opened, and the boat is transferred into a load lock chamber. In a separation step (S140), the shutter is closed to separate the processing chamber from a space in the load lock chamber. In a cooling step (S150), an inside of the load lock chamber is cooled. Hereinafter, the respective steps will be described in more detail.

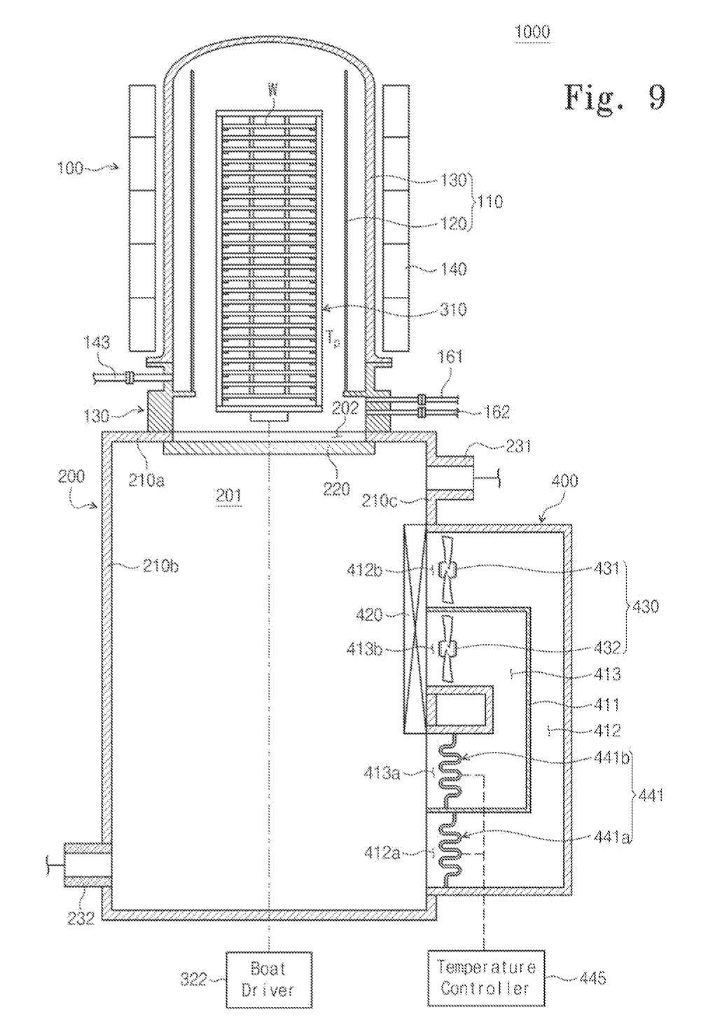

FIG. 9 is a schematic view illustrating the process treating step (S120) set forth in FIG. 8.

Referring to FIG. 9, in the process treating step S120, the boat 200 is positioned in the process tube 110. The shutter 220 closes the opening 202 to separate the inside of the process tube 110 from the inside of the load lock chamber 200. The inside of the process tube 110 is heated to a process temperature Tp by the heating member 140. While the inside of the process tube 110 is maintained at the process temperature Tp, a process gas is supplied from the process gas supply nozzle 161 to the process tube 110. The process gas is deposited on substrates W mounted in the boat 310 while the process gas is introduced into the inner tube 120 and flows from bottom to top of the inner tube 120. While the deposition process is performed, residual gases are exhausted to the outside through the gas exhaust pipe 163 while flowing from top to bottom along the space between an outer tube 130 and the inner tube 120.

When the process treatment for the substrates W is completed, the heating member 140 maintains the temperature of the process tube 110 at a preliminary temperature Ts. While the inside of the process tube 110 is maintained at the process temperature Tp, a purge gas is supplied from the purge gas supply nozzle 161 to the inside of the process tube 110. The purge gas exhausts the process gas remaining in the process tube 110 to the outside through the gas exhaust pipe 163.

When the inner temperature of the process tube 110 is maintained at the preliminary temperature Ts, the shutter 220 opens the opening 202. The boat 310 is transferred from the process tube 110 to the inside of the load lock chamber 200 through the opening 202. While the boat 310 is transferred, thermal energy in the process tube 110 is supplied to the inside of the load lock chamber 200 through the opening 202. As a result, the inner temperature of the load lock chamber increases sharply.

When the boat 310 is positioned in the load lock chamber 200, the shutter 220 closes the opening 202 to separate the inside of the process tube 110 from the inside of the load lock chamber 200.

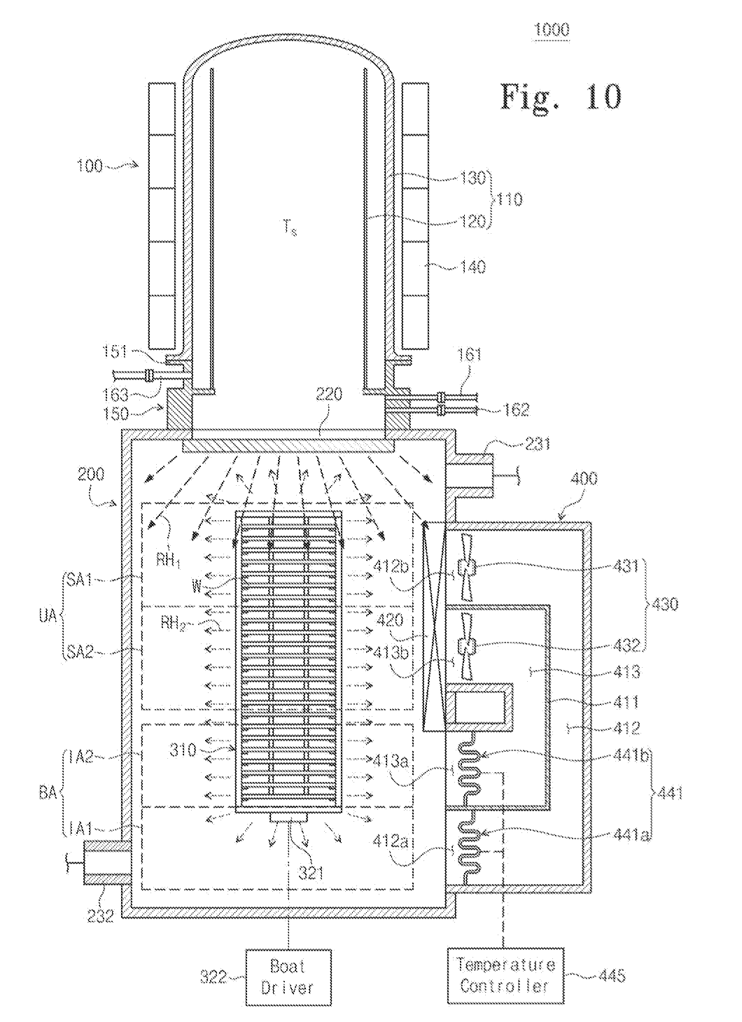

FIG. 10 is a schematic view illustrating the cooling step set forth in FIG. 8.

Referring to FIG. 10, while the boat 310 is positioned in the load lock chamber, a gas is supplied to the inside of the load lock chamber 200 through the gas supply pipe 231. The gas supplied through the gas supply pipe 231 purges the gas remaining in the load lock chamber 200. Some of the gas remaining in the load lock chamber 200 is exhausted to the outside through the gas exhaust pipe 232.

The rest of the gas remaining in the load lock chamber 200 circulates along passages 412, 413 formed in the circulation duct 410. The gas remaining in the lower area or region BA of the load lock chamber 200 is introduced through a first inlet 412a and a second inlet 413a to circulate through the first passage 412 and the second passage 413. While the gas circulates through the circulation duct 410, the temperature of the gas is controlled by the cooler 441. The gas circulating through the first passage 412 is cooled by the first cooler 441a, and the gas circulating through the second passage 413 is cooled by the second cooler 441b. The respective coolers 441a, 441b cool the gases circulating through the respective passages 412, 413, independently. According to an embodiment, the gas circulating through the first passage 412 is cooled to a lower temperature than the gas circulating through the second passage 413.

The gas that has circulated through the circulation duct 410 is supplied to an upper area or region of the load lock chamber 200. The gas that has circulated through the first passage 412 is supplied to the first supply area or region SA1 through the first outlet 412b. The gas that has circulated through the second passage 413 is supplied to the second supply area or region SA2 through the second outlet 413b.

By the foregoing gas circulation, the inside of the load lock chamber 200 is cooled at different temperatures according to the area or region of the load lock chamber 200. The inner cooling degree of the load lock chamber 200 is varied according to a vertical direction of the load lock chamber 200. Since the gas supplied through the first outlet 412b is kept at a lower temperature than the gas supplied through the second outlet 413b, the amount of cooling in the first supply area or region SA1 is higher than that in the second supply area or region SA2.

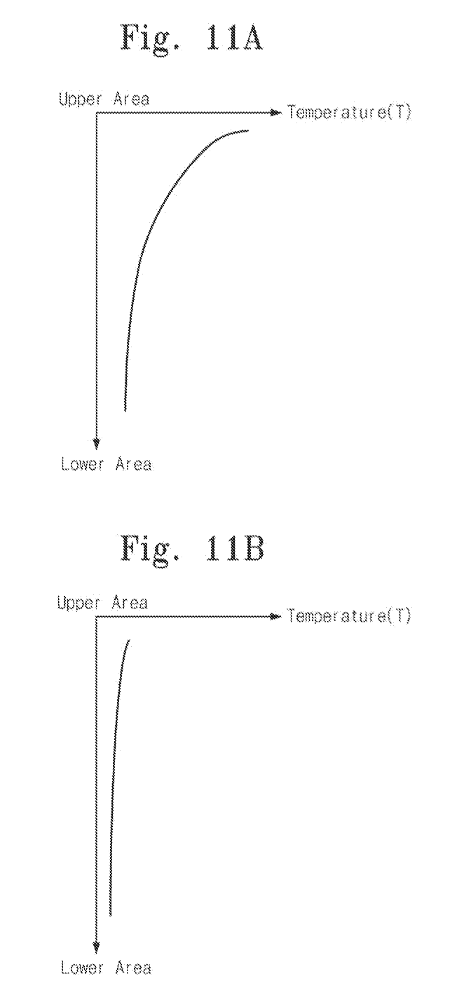

FIG. 11A is a graph showing an inner temperature of the load lock chamber before the cooling member according to the inventive concept is driven, and FIG. 11B is a graph showing the inner temperature of the load lock chamber while the cooling member according to the inventive concept is driven.

Referring to FIGS. 10 and 11A, the upper area or region UA and the lower area or region BA in the load lock chamber 200 increase in temperature due to a thermal energy RH1 supplied from the process tube 110 through the opening 202, and a thermal energy RH2 radiated from the substrates W. The upper area or region UA in the load lock chamber 200 is kept at a higher temperature than the lower area or region BA due to the radiant energy RH1 supplied from the process tube 110. Therefore, the temperature of the interior of the load lock chamber 200 increases overall, and the upper area or region UA adjacent to the process tube 110 is kept at the higher temperature than the lower area or region BA. Thus, the upper area or region UA and the lower area or region BA have a great temperature difference.

Due to the increase in the inner temperature of the load lock chamber, an inner structure of the load lock chamber 200 is exposed to a high temperature environment. In particular, the structure disposed at the upper area or region UA is exposed to a higher temperature than the structure disposed at the lower area or region BA. A thermal deformation occurs in the inner structure exposed to the high temperature environment. For example, grease provided to the boat driver 322, or glue provided to the filter 420 may be easily thermally deformed under a high temperature environment. The thermal deformation of the inner structure acts as a supply source of fine particles which may contaminate the substrates subject to all process treatments.

Referring to FIGS. 10 and 11B, while the cooling member 400 is driven, the gas cooled through the outlets is supplied to the upper area or region UA in the load lock chamber 200. The load lock chamber 200 is cooled by the supplied gas, and thus the inside of the load lock chamber 220 is kept at a lower temperature than that in FIG. 11A.

Since the first supply area or region SP1 adjacent to the processing chamber 100 is cooled by a gas cooled to a lower temperature, i.e., a gas exhausted through the first outlet 412b, although a radiant energy is provided from the process tube 110, the temperature does not rise substantially. As a result, the inside of the load lock chamber 200 is cooled to a uniform temperature along the vertical direction.

Thus, since the inside of the load lock chamber 200 is cooled uniformly, the inner structure of the load lock chamber 200 is prevented from being exposed to a high temperature environment.

While the foregoing embodiments show and describe that the cooling member 400 cools the load lock chamber 200 with gas circulation in the load lock chamber 200, the present invention is not limited thereto.

Unlike the foregoing embodiments, the cooling member may provide a gas at different temperatures according to area or region from the gas supply unit connected to the load lock chamber to each area or region in the load lock chamber 200.

Also, the cooling member may include a plurality of coolers provided in the load lock chamber. The plurality of coolers may be disposed spaced apart from each other in a vertical direction in the load lock chamber. The gas in the cooler disposed in the upper area or region of the load lock chamber may be controlled to a lower temperature than the gas in the cooler disposed at the lower area or region.

According to the embodiments of the present invention, the inside of the load lock chamber is cooled at different temperatures according to area or region in the vertical direction thereof.

Also, the inner structure of the load lock chamber can be prevented from being exposed to a high temperature, so that occurrence of fine particles due to thermal deformation of the inner structure can be prevented.

In addition, since a difference between the process temperature and the preliminary temperature is decreased, the process time due to the temperature control can be shortened.

The above-described subject matter is to be considered illustrative and not restrictive, and the appended claims are intended to cover all such modifications, enhancements, and other embodiments, which fall within the true spirit and scope of the inventive concept. Thus, the scope of the inventive concept is to be determined by the broadest permissible interpretation of the following claims and their equivalents, and shall not be restricted or limited by the foregoing detailed description.

1. An apparatus for treating a substrate, comprising:
a processing chamber providing a space where a process is performed;
a heating member heating the processing chamber;
a load lock chamber coupled to the processing chamber;
a boat supporting the substrate;
a boat driving member transferring the boat between the processing chamber and the load lock chamber; and
a cooling member cooling an inside of the load lock chamber,
wherein the cooling member is provided such that the inside of the load lock chamber is cooled at different temperatures according to region in the load lock chamber.

2. The apparatus of claim 1, wherein:
the cooling member comprises a circulation duct having a plurality of passages for circulating a gas in the load lock chamber;
each of the plurality of passages has an inlet through which the gas is introduced from the inside of the load lock chamber, and an outlet through which the gas is exhausted to the load lock chamber; and
the outlets of the plurality of passages are positioned at different heights.

3. The apparatus of claim 2, wherein the plurality of passages comprise:
a first passage having a first outlet; and
a second passage having a second outlet disposed at a lower level than the first outlet,
wherein the cooling member further comprises a first cooler positioned in the first passage to cool the gas.

4. The apparatus of claim 3, wherein the cooling member further comprises a second cooler positioned in the second passage to cool the gas.

5. The apparatus of claim 4, wherein the cooling member further comprises a temperature controller independently controlling the first cooler and the second cooler.

6. The apparatus of claim 3, wherein:
the first passage has a first inlet;
the second passage has a second inlet; and
the first inlet is positioned below the second inlet.

7. The apparatus of claim 3, wherein the cooling member is provided along a passage of the circulation duct and further comprises a wall partitioning the first passage and the second passage from each other.

8. The apparatus of claim 3, wherein the second passage is positioned at an area between the load lock chamber and the first passage.

9. The apparatus of claim 2, wherein the boat is provided such that the plurality of substrates are stacked spaced apart from each other in the vertical direction.

10. The apparatus of claim 6, wherein the inside of the load lock chamber is partitioned into:
an upper region to which the gas is supplied from the first and second outlets; and
a lower region positioned below the upper region, from which the gas is supplied to the first and second inlets;
wherein the upper region comprises:
a first supply region to which the gas is supplied from the first outlet; and
a second supply region disposed below the first supply region, to which the gas is supplied from the second outlet, and
wherein the lower region comprises:
a first introduction region to which the gas is introduced through the first inlet; and
a second introduction region disposed above the first introduction region, to which the gas is introduced through the second inlet.

11. The apparatus of claim 1, wherein the load lock chamber is disposed below the processing chamber.

12. The apparatus of claim 1, wherein the inside of the load lock chamber is cooled at different temperatures according to region of the load lick camber in a vertical direction.

13. An apparatus for treating a substrate, comprising:
a chamber having a space formed therein;
a circulation duct providing a plurality of passages through which a gas in the chamber is circulated; and
a cooling member installed in the circulation duct to cool the gas in the plurality of passages, independently.

14. The apparatus of claim 13, wherein the plurality of passages have inlets through which the gas is introduced from the chamber, and outlets through which the gas is exhausted to the chamber,
wherein the outlets are positioned at different heights.

15. The apparatus of claim 14, wherein the circulation duct comprises:
a first passage having a first outlet; and
a second passage disposed at a lower position than the first outlet, and having a second outlet,
wherein the cooling member comprises:
a first cooler disposed on the first passage; and
a second cooler disposed on the second passage.

16. The apparatus of claim 15, wherein the cooling member further comprises a temperature controller controlling the first cooler and the second cooler independently.

17. The apparatus of claim 15, wherein the cooling member further comprises a wall provided along a passage of the circulation duct and partitioning the first passage and the second passage from each other.

18-27. (canceled)
